(19) United States
(12) Patent Application Publication
(10) Pub. No.: US 2026/0148600 A1
(43) Pub. Date: May 28, 2026

(54) SYSTEMS AND METHODS FOR CONTROLLING MOVABLE BARRIER OPERATORS WITH UNPAIRED CONTROL DEVICES

(71) Applicant: The Chamberlain Group LLC, Oak Brook, IL (US)

(72) Inventor: Oddy Nopporn Khamharn, Lombard, IL (US)

(21) Appl. No.: 18/957,950

(22) Filed: Nov. 25, 2024

(51) Int. Cl. G07C 9/27; E05F 15/77; G07C 9/20

(52) U.S. Cl. CPC G07C 9/27; E05F 15/77; G07C 9/215; E05Y 2900/106

(57) ABSTRACT

A system for providing access to a designated venue. The system includes a control device associated with an operator account belonging to a user and configured to transmit control signals for actuating movable barriers. The system further includes an operator server associated with the control device, remote from the designated venue, and operatively coupled to a user interface to receive a login credential from the user. The operator server is configured to, in response to determining that the login credential corresponds with the operator account of the user, determine a device identifier associated with control device. The operator server is further configured to transmit the device identifier to a venue processor associated with the designated venue for the venue processor to use in operating a barrier system of the designated venue.

### BACKGROUND

In traditional remote-controlled movable barrier systems, a control device is operatively paired with one or several local movable barrier operators. For example, a homeowner may pair a control device with the garage door operator. Similarly, a business owner may pair a single control device with multiple bay door operators of a storage facility. Pairing operations between a control device and an operator traditionally must be performed each time a user desires to utilize the control device for controlling a given operator, as the operator must learn to recognize the signals from the control device as signals authorized for controlling the operator. Accordingly, traditionally, the control device and operator must be relatively close to each other during the pairing operation so that the operator can receive and process the control device’s signals.

### SUMMARY

The disclosed examples are described in detail below with reference to the accompanying drawing figures listed below. The following summary is provided to illustrate some examples disclosed herein.

Example solutions include systems and associated methods for providing access to a designated venue. One such system includes a control device associated with an operator account belonging to a user and configured to transmit control signals for actuating movable barriers. The system further includes an operator server associated with the control device, remote from the designated venue, and operatively coupled to a user interface to receive a login credential from the user. The operator server is configured to, in response to determining that the login credential corresponds with the operator account of the user, determine a device identifier associated with control device. The operator server is further configured to transmit the device identifier to a venue processor associated with the designated venue for the venue processor to use in operating a barrier system of the designated venue.

### BRIEF DESCRIPTION OF THE DRAWINGS

The disclosed examples are described in detail below with reference to the accompanying drawing figures listed below:

FIG. 1 illustrates a movable barrier system, according to an example of this disclosure;

FIG. 2 is a block diagram illustrating an example of a user-operated control device of the system of FIG. 1;

FIG. 3 is a block diagram illustrating an example of a movable barrier operator of the system of FIG. 1;

FIGS. 4 and 5 illustrate movable barrier systems incorporating a remote server;

FIGS. 6 and 7 are block diagrams illustrating a movable barrier operator using data stored in a remote server for controlling operations of a movable barrier;

FIG. 8 is a flowchart illustrating a method of operating a movable barrier system using data stored in a remote server;

FIGS. 9-11 are block diagrams illustrating venue access systems utilizing data stored in a remote server for granting access to a designated venue;

FIG. 12 is a flowchart illustrating a method of granting access to a venue including a venue access system utilizing data stored in a remote server;

FIG. 13 is a block diagram illustrating a remote server coordinating with a control device and a venue access system for granting access to a designated venue; and

FIG. 14 is a flowchart illustrating a method of a granting access to a venue including a remote server coordinating operations between a control device and a venue access system.

Corresponding reference characters indicate corresponding parts throughout the drawings.

### DETAILED DESCRIPTION

In traditional remote-controlled movable barrier systems, a control device must be previously paired with the moveable barrier operator in order to control operations of the operator. Because of this, there are various situations in which use of a control device is not considered as an option for controlling a movable barrier operator. For example, when a homeowner replaces or buys a new garage door operator, they are unable to use an existing control device (such as one integrated with their car, for example) for opening or closing the garage door until the new operator is paired with the existing control device. Similarly, venue business managers with controlled access entry points are unable to allow patrons to enter the venue using their own control devices, as the patron control devices are not already paired with the operators controlling the business’s entry points. As will be discussed in greater detail below, example solutions of this disclosure provide for using control devices with operators previously unpaired with the control devices.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

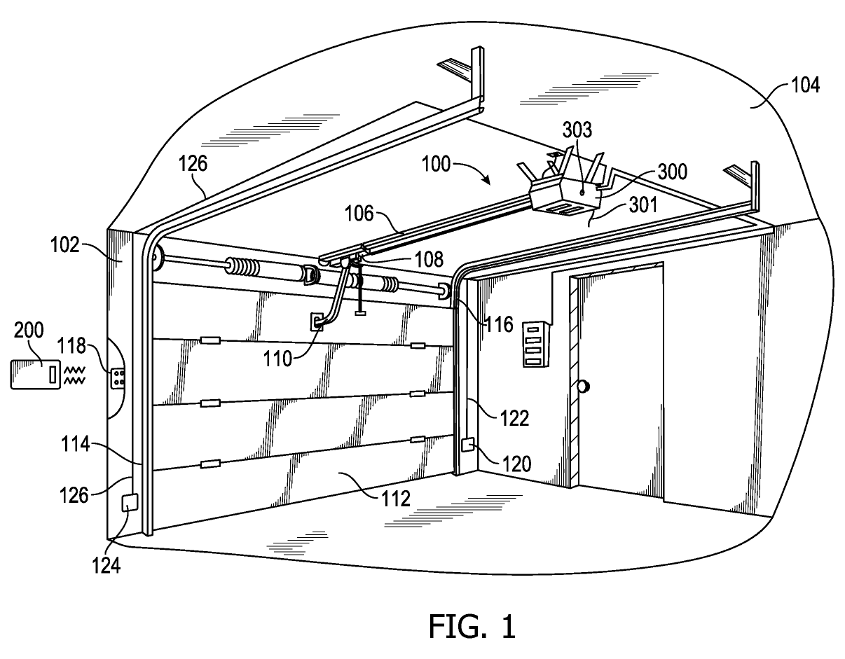

FIG. 1 illustrates a movable barrier operator system 100 that includes a movable barrier operator 300 and a control device 200. As shown, according to some examples, system 100 is utilized in a garage 102 setting. Control device 200 can comprise any of various known control devices, such as, for example, a handheld device such as a remote control, a wall-mounted control device, a control device integral to a vehicle, or the like. In the illustrated example, operator 300 is mounted to the ceiling 104 of the garage 102 and includes a rail 106 extending therefrom with a releasable trolley 108 attached having an arm 110 extending to a barrier 112 positioned for movement along a pair of door tracks 114, 116. In this example depicting a garage 102 setting, barrier 112 comprises a garage door. Control device 200 is adapted to send signals to and receive signals from the operator 300. An antenna 301 may be positioned on the operator 300 and coupled to a receiver as discussed hereinafter in order to receive transmissions from the control device 200. An external control pad 118 may also be positioned on the outside of garage 102 and include a user interface thereon for receiving user commands that are communicated via radio frequency transmission with the antenna 301 of the operator 300. In some examples, the external control pad 118 is accessible from an outside location and in some examples constitutes a control device 200. An optical emitter 120 may be connected via a power and signal line 122 to the operator 300 with an optical detector 124 connected via a wire 126 to the operator 300 in order to prevent closing of the barrier 112 on a person or object inadvertently in the door’s path. An input such as a button or switch 303 may be provided for switching the operator 300 between modes, such as operating mode and learn mode. FIG. 1 depicts an illustrative example of a movable barrier system according to one example of this disclosure in a garage environment, and those with skill in the art will recognize that various other movable barrier examples in various other settings fall within the scope of this disclosure. For example, other movable barrier environments of this disclosure include environments such as over-head doors used for bays, room dividers, gates, and any other movable barrier controlling or providing access to an area.

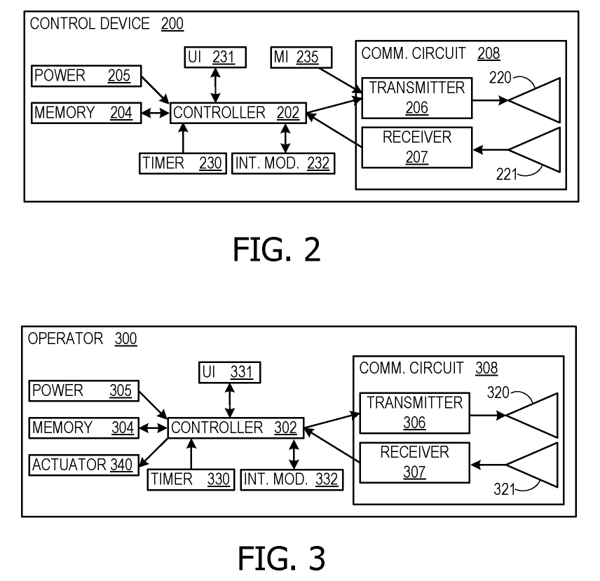

FIG. 2 illustrates a block diagram of the control device 200. Control device 200 includes a communication circuit 208 comprising both a transmitter 206 and receiver 207 (which may be combined into a single transceiver mechanism) in operative communication with antennas 220 and 221, respectively. The antennas can be positioned in, on, or extending from the control device 200, wherein the transmitter 206 and receiver 207 are configured for wirelessly transmitting and receiving transmission signals to and from the operator 300, including transmission signals that contain a first rolling access code with a fixed code portion and a rolling code portion. In some examples, both the transmitter and receiver may communicate with a single antenna or multiple antennas, and in some examples the transmitter and receiver may be configured to be a single transceiver device in communication with a single antenna. Further, for communication and connectivity, control device 200 includes an internet module 232 configured to be utilized for connecting control device 200 to the internet. Internet module 232 can comprise various communication technologies such as technologies for connecting to Wi-Fi and/or cellular internet networks. In some examples, internet module 232 is integrated with communication circuit 208 and, in some examples, communication circuit 208 and internet module 232 are separate from each other.

Control device 200 also includes a controller 202 in operative communication with the transmitter 206 and a memory 204 and is configured for processing data and carrying out commands. Memory 204 may be, for instance, a non-transitory computer readable medium, and may have stored thereon instructions that when executed by a controller circuit cause the controller circuit to perform operations. A power source 205 is coupled to the controller 202 and/or other components, and may be routed in some embodiments so that a user interface (UI), such as UI 231, couples/decouples the power source to other components so that power is supplied only upon activation of the UI 231 or a specified time thereafter. Controller 202 is configured to generate the transmission signal with a signal identifier and cause the transmitter 206 to transmit the signal, and the receiver 207 is configured to receive responsive transmissions from one or more operators 300. Optionally, a timer 230 in communication with the controller 202 enables the controller 202 to determine the time of incoming and outgoing signal transmissions and provides reference for the controller 202 to enable and disable the transmitter 206 and/or receiver 207 of the device. In some embodiments, a manual setting interface (MI) 235 may be provided, which in some forms may include one or more dual in-line package (DIP) switches or other devices configured to allow a user to configure a setting or state of the controller 202. MI 235 may be operatively coupled to transmitter 206 in order to allow for signal transmissions including information regarding the current setting or state of the manual setting interface. Memory 204 is connected for operative communication with controller 202 and is configured to store data such as codes and, in some examples, other information for outgoing transmissions. Memory 204 is further configured to store fixed and/or changing or variable code information for comparison to incoming transmissions.

UI 231 may include one or more user-operable switches for inputting commands to the control device 200, for example to issue a barrier movement command or a learning command. UI 231 may be associated with a button, lever, or other device to be actuated, for example by a user’s hand or other actions, events, or conditions. As other examples, the UI 231 may be voice operated or operated by a user contacting a touch-sensitive screen as the location of an object displayed on the screen. The UI 231 may include multiple buttons, levers, switches, displays, microphone(s), speaker(s), or other inputs associated with different tasks, or operations, to be carried out by the operator 300. As one example, the UI 231 includes a plurality of mechanical buttons that each operate a respective switch. As another example, UI 231 includes a display with one or more virtual buttons.

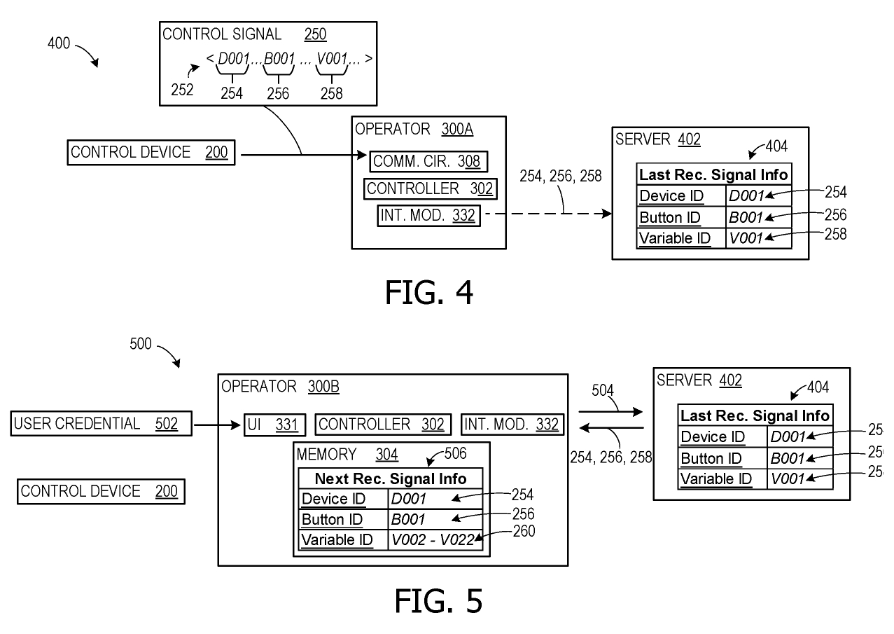

FIG. 3 illustrates a block diagram of operator 300. According to various examples, the operator 300 includes a controller 302 in communication with a memory 304 and is configured for storing and retrieving data to and from memory 304 as well as processing data and carrying out commands. A power source 305, such as an AC power conduit, battery, or other type of power source, supplies electricity to the controller 302 to allow operation. As an example, power source 305 may include an AC power conduit, a power conditioning circuit, a battery, and/or a battery charging circuit. Operator 300 also includes a communication circuit 308 comprising a wireless transmitter 306 and receiver 307 (or combination transceiver device) in operative communication with the controller 302. As shown, transmitter 306 communicates with a first antenna 320 and receiver 307 communicates with a second antenna 321, but both devices may communicate with a single antenna or multiple antennas, and in some embodiments the device may be configured to have a single transceiver device in communication with a single antenna. The antennas may be positioned in, on, or extending from the operator 300. In this regard, signals, such as radio frequency or other wireless transmission carriers, may be sent to and received from the control device 200 according to a variety of frequencies or modulations. Signals may be modulated in a number of different ways; thus, the control device 200 and movable barrier operator 300 may be configured to communicate with one another via a variety of techniques. Further, for communication and connectivity, operator 300 includes an internet module 332 configured to be utilized for connecting operator 300 to the internet. Internet module 332 can comprise various communication technologies such as technologies for connecting to Wi-Fi and/or cellular internet networks. In some examples, internet module 332 is integrated with communication circuit 308 and, in some examples, communication circuit 308 and internet module 332 are separate from each other.

Controller 302 of the operator 300 is also in communication with an actuator such as an actuator 340 in order to carry out an operation such as moving a barrier, which may include for example lifting or lowering a bay or a garage door; sliding, swinging, or rotating a gate; or otherwise moving or repositioning a barrier structure. Actuator 340 can comprise any actuating device for moving the associated movable barrier, such as, for example, a motor, a pneumatic or hydraulic actuator, a linear motion actuator, a rotary actuator, or the like.

User Interface (UI) 331, which includes one or more input devices such as buttons, keys or a touch-screen interface, for example, receives user input to override the controller 302 or place the controller in and out of a learning mode in which the operator 300 may be paired with a user-operated device, such as control device 200, by exchanging and storing messages.

The term controller refers broadly to any microcontroller, application specific integrated circuit (ASIC), field programmable gate array (FPGA), computer, state machine, or processor-based device with processor, memory, and programmable input/output peripherals, which is generally designed to govern the operation of other components and devices. It is further understood to include common accompanying accessory devices. The controller can be implemented through one or more processors, microprocessors, central processing units, logic, local digital storage, firmware, software, and/or other control hardware and/or software and may be used to execute or assist in executing the steps of the processes, methods, functionality, and techniques described herein. Furthermore, in some implementations the controller may provide multiprocessor functionality. These architectural options are well known and understood in the art and require no further description here. The controllers may be configured (for example, by using corresponding programming stored in a memory as will be well understood by those skilled in the art) to carry out one or more of the steps, actions, and/or functions described herein.

When a user actuates UI 231 of the control device 200, such as by pressing a button designated as performing a particular action, the controller 202 activates the transmitter 206 to transmit through antenna 220 a message based on information stored in memory 204. The message is received by the receiver 307 of operator 300 and communicated to the operator’s controller 302. In some embodiments, the controller 302 verifies the message by comparing the message to stored information from the operator’s memory module 304, and upon verification the controller 302 is configured to cause transmission of a response signal from the transmitter 306 through an antenna 320. If the message from the user-actuated control device 200 includes information relating to timing parameters for a response, the operator’s controller 302 receives time information from a timer 330 in order to determine when to transmit the response in order to comply with timing parameters of the control device 200.

The control device 200 may be configured to verify that the response from the operator 300 complies with transmitted timing requirements in any number of ways. In some embodiments, controller 202 may compare a time stamp or other timing information relating to the operator’s response to the transmitted time parameter using timer 230. In some embodiments, receiver 207 is generally inactive, but switched on by controller 202 only for a short time period consistent with the transmitted timing parameter. For instance, controller 202 may switch on receiver 207 for a window of time matching a time window transmitted in an outgoing message through transmitter 206, and upon expiration of the time window according to timer 230, controller 202 switches receiver 207 off again. Timing information may be either relative, for instance a specified number of seconds, milliseconds, or nanoseconds after transmission of an outgoing signal or other event, or may be absolute such as standard date and time information for a specific time zone. A timing synchronization protocol may be provided in some forms in order to maintain precision of timing with other devices despite drift or other factors.

As discussed, communication circuits 208, 308 can comprise two-way communication circuits configured to both transmit and receive communications signals. In some examples, communication circuits 208, 308 comprise short-range wireless communication modules, such as ultra-wideband (UWB), Bluetooth, or Bluetooth low energy (BLE) modules or circuits, for example. As such, as those with skill in the art will understand, all wireless communication connections referred to herein utilized by operators 300 and control devices 200 can be any known short-range wireless communication connections, such as Bluetooth or BLE connections, for example.

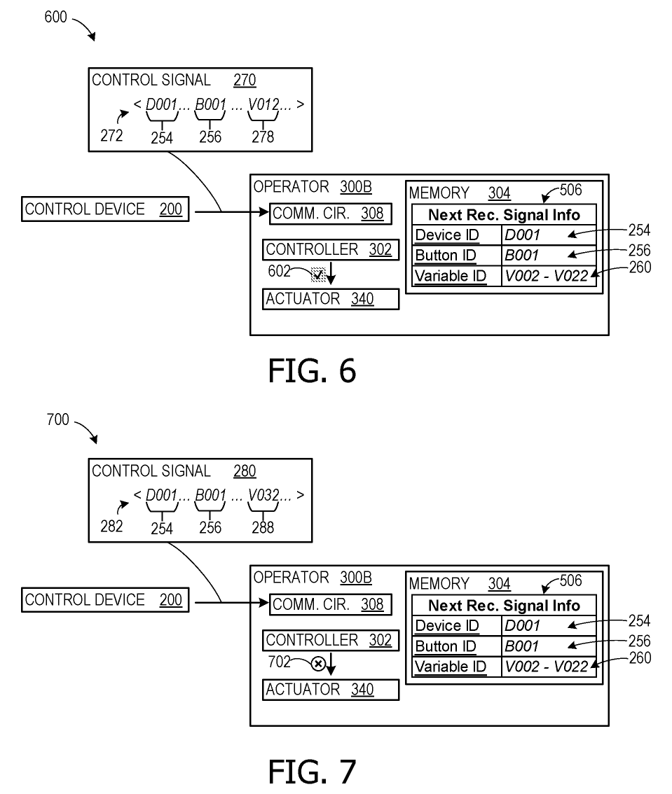

FIG. 4 is a block diagram illustrating a movable barrier system 400. System 400 includes a control device 200, an operator 300A, substantially the same as operator 300 previously discussed, and a remote sever 402. According to various examples, control device 200 and operator 300 are communicatively coupled via their respective communication circuits 208 and 308. That is, control device 200 can send communication signals via communication circuit 208 that are received by operator 300A via communication circuit 308, and vice versa. As previously discussed, communication between communication circuits 208, 308 can be achieved according to any of a number of technologies, such as, for example, radio-frequency (RF) signals or Bluetooth signals.

Controller 202 of control device 200 can generate contents of control signals for transmitting to operator 300. For illustrative purposes, FIG. 4 illustrates a control signal 250 (generated by controller 202) being transmitted by control device 200 (via communication circuit 208) and received by operator 300A (via communication circuit 308). Controller 202 generates control signals to include various pieces of data. Control signal 250, includes a protocol data unit (PDU) 252 which, as those with skill in the art will understand, is comprised of various protocol, control, and device data. PDU 252 includes a device identifier (ID) 254 which identifies the device 200. Each control device 200 can be associated with a device ID that is specific to the control device. The device ID is an identifier unique to each control device, similar to a serial number, and is included in each transmission sent from control device 200 for identifying the source of the transmission. The device ID 254 is included in section of the PDU 252 including so receiving devices, such as operator 300A, can identify the source of a signal from analyzing the section of the PDU including the device ID 254. PDU 252 further includes section including a button ID 256 which identifies which interactive button of UI 231 was activated to generate signal 250. That is, while the same device ID is included in each signal sent from control device 200, differing button IDs are included in control signals depending on which button of UI 231 was activated to generate the signal. This button identifier 256 is included in a section of the PDU 252 so receiving devices, such as operator 300A, can identify the button source of a signal from analyzing the section of the PDU 522 including a button ID 256. For example, a receiving device may be programed to only operate in response to receiving signals generated in response to a certain button of control device 200 being activated. PDU 252 can further include a variable ID section where a variable ID 258 can be included to allow for encrypted communication between the control device and operator 300. That is, control device 200 and operator 300A can be paired together to communicate via an encrypted communication protocol, where each transmission between the two devices includes a variable ID that conforms to an encryption method known and synced between the two devices such that each device knows what value to expect in the variable ID section of a transmission and checks the actual variable ID value received against the expected variable ID in verifying the received transmission. In some examples, the variable ID is created via an encryption algorithm, such as a rolling code algorithm, for example. As shown for this illustrative example, for control signal 250 the device ID 254 is illustrated as “D001”, the button ID 256 is illustrated as “B001”, and the variable ID 258 is illustrated as “V001”.

Control signal 250 is illustrative of a typical control signal sent from control device 200 to operator 300 during normal operation. For example, control signal 250 can be transmitted to control operator 300A to open or close barrier 112 by actuating actuator 340. Operator controller 302 can be programmed to store data associated with control signal 250 on a remote server, such as server 402. Server 402 can be an offsite or cloud server associated with a supplier or manufacturer of control device 200 and/or operator 300A. For example, a homeowner may purchase control device 200 and operator 300 for use in their garage, and register their purchased devices to a customer account stored on and facilitated by server 402 so that information associated with their items can be stored on server 402, for purposes that will become clearer below. As shown, in some examples, operator 300A is operatively coupled with server 402 via a network or internet connection via internet module 332. In some examples, after receiving control signal 250, controller 302 identifies device ID 254, button ID 256, and the variable ID 258 from PDU 252 and stores one, some, or all of the device ID 254, button ID 256, and variable ID 258 in server 402. As shown, the IDs 254, 256, 258 are stored in a table 404 of server 402 where the information of the control signal last received by operator 300A is stored. So, because control signal 250 in this example system 400 is the “last received” control signal of operator 300A, table 404 is populated with IDs 254, 256, 258 from control signal 250. In some examples, the next time operator 300A receives a new signal from control device 200, controller 302 transmits that signal’s IDs for populating table 404. However, according to various examples, controller 302 may not update table 404 with control signal IDs every time a control signal is received. In some example, controller 302 may update table 404 periodically, such as once every five or ten times a control signal is received. Storing the various control signal IDs in table 404, which is associated with an account of the owner of control device 200 and operator 300A, allows for this data to be utilized in future use-cases where such data has not previously been available. In many cases, access to this data eliminates the need for pairing control device 200 with a new operator 300, as will be discussed in greater detail below.

FIG. 5 illustrates a movable barrier system 500 substantially similar to system 400 previously discussed. However, different from system 400, system 500 includes operator 300B (substantially similar to operator 300) rather than operator 300A. Operator 300B is a different operator than operator 300A but, as will be discussed in greater detail below, is still compatible with and configured to be controlled by control device 200. Further, as will be discussed, operator 300B can be operated using control device 200 utilizing data stored in server 402 without needing to perform a traditional pairing process between control device 200 and operator 300B. Those with skill in the art will recognize various scenarios in which this sort of compatibility is useful. For example, a homeowner may have originally bought operator 300A for actuating their garage door and paired control device 200 to control operator 300A. At a later time, the homeowner may purchase operator 300B to replace operator 300A in actuating the garage door. For any of a number of reasons, the homeowner may wish to continue to use their existing control device 200 with the new operator 300B. For example, the control device 200 may be integral with the homeowner’s vehicle. Traditionally, the homeowner would have to perform a new pairing process so that operator 300B can learn control device 200. However, system 500 allows for control device 200 to control the new operator 300B without performing the traditional pairing process.

As shown, the user provides the new operator 300B with a user credential 502. In some examples, the user enters the user credential 502 into UI 331. The user credential is associated with the user’s account associated with the control device and operators 300A, 300B. For example, the user credential can be login information such as a username and password for the user account. In some examples, the user enters the user credential 502 in order to register the new operator 300B to the user’s account and configure the operator 300B to be operated by the user’s existing control device 200. After receiving the user credential 502, the controller 302 submits a request 504, which includes the user credential 502, to server 402 via internet module 332. Request 504 is sent requesting information related to a last known use of control device 200 with operator 300A, such as device IDs 254, 256, 258, stored in table 404, previously discussed. As previously discussed, server 402 is operated by a manufacture or operator of the devices of systems 400, 500, and as such store, hosts, and manages user account information. Server 402 receives request 504 and, in response to user credential 502 satisfying account information of a registered user, provides the requested data from table 404. In some examples, server 402 provides device ID 254, button ID 256, and variable ID 258 stored in table 404. In some examples, only one or some of IDs 254, 256, 258 are sent from server 402 to operator 300B in response to request 504 rather than all three IDs 254, 256, 258.

According to various examples, in system 500 and the other systems disclosed herein, tokenized credentials are used as part of the request from operator 300B to server 402. In some examples, the user provides a credential related to the account with a parking reservation service. This account can be linked with their account maintained by server 402 via tokenized credentials that securely link the parking user account information to the user account maintained by the server 402.

Operator controller 302 receives the IDs 254, 256, 258 and, using, the IDs, populates table 506 stored in memory 304. As shown, table 506 is used to store control signal data expected in a next received control signal from control device 200. Thus, by utilizing the data store in server 402, operator 300B can store expected signal data belonging to existing control device 200 without having to perform a traditional pairing process with control device 200. As shown, in some examples, the device ID 254 and button ID 256 are the same the values stored in server 402, as these values will not change with a next activation of control device 200. That is, as previously discussed, the device ID and button ID of a control signal from control device 200 remain constant each time the button is activated. However, as previously discussed, the variable ID of the control signals changes with each transmission according to an encryption algorithm, such as a rolling code. Operator 300B comes equipped with the encryption algorithm, but variable ID 258 from server 402 provides a starting point so that operator 300B knows what to expect in a next anticipated control signal from control device 200. Keeping with the numbering convention already established, variable ID 258 is shown as “V001” and a next activation of control device 200 results in controller 202 generating a variable ID according to the encryption algorithm that can be referred to as “V002”. The next activation of control device 200 results in controller 202 generating a variable ID according to the encryption algorithm that can be referred to as “V003”, and so on. In some examples, instead of calculating only the next expected variable ID (that is, after V001, expect V002), controller 302 of operator 300B calculates a range 260 of expected variable IDs in a next received signal for populating table 506. As shown, in some examples, the range 260 comprises the next 20 expected variable IDs (V002-V022) expected after the variable ID 258 stored in table 404 (V001). Range 260 can comprise more or less than 20 variable IDs, according to various examples.

There are various reasons for calculating a range 260 of expected variable IDs in a received signal rather than just the next expected variable ID. For example, in system 400, operator 300A may be replaced with a new operator 300B. Before replacing operator 300A with operator 300B, the homeowner may have activated control device 200 numerous times in attempt to operate operator 300A with the control device 200, resulting in the generation and transmission of many signals transmitted from control device 200 but not received by the operator 300A. Additionally, as previously discussed, in some examples operator 300A may only transmit IDs 254, 256, 258 to server 402 on a periodic basis rather than after every received signal. As such, the recorded variable ID in server 402 may not align with the variable ID of the last transmitted signal from control device 200.

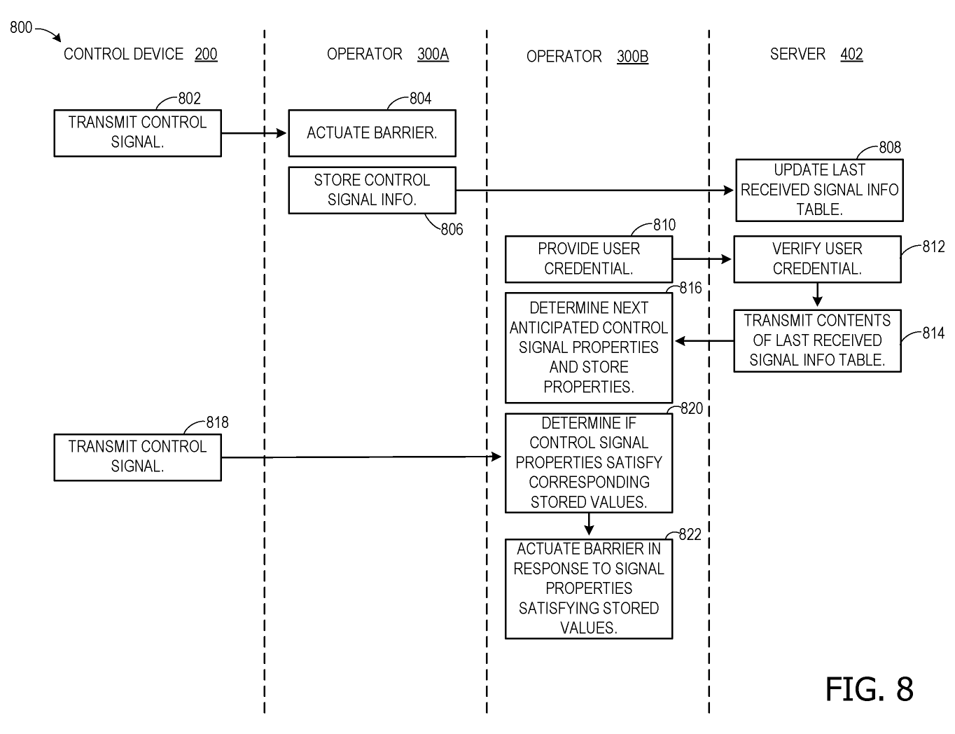

FIGS. 6 and 7 illustrate how operator 300B uses table 506 in processing signals received from control device 200. FIG. 6 illustrates system 600 in which operator 300B receives its first control signal 270 from control device after 200 receiving the last recorded control device data from server 402 and generating the contents of table 506. As shown, control device 200 generates and transmits control signal 270 which is received by communication circuit 308 of operator 300. Control signal 270 comprises a PDU 272 which includes device ID 254, button ID 256, and variable ID 278. As previously discussed, device ID and button ID are common to all signals sent from control device 200 in response to the corresponding button being pressed, and variable ID 278 is different for each control signal from the control device 200 based on an encryption algorithm known by the control device 200 and operator 300B. Controller 302 of operator 300B analyzes the contents of PDU 272 and is configured to compare the values of the IDs of PDU 272 against the associated values stored in table 506. In response to the IDs included in PDU 272 matching the associated IDs stored in table 506, controller 302 is configured to verify the control signal as being sent from a source meant for controlling operator 300B and actuate the associated barrier with actuator 340. In response to determining that one of the IDs of PDU does not correspond with its associated ID in table 506, controller 302 is configured to ignore the received signal and not actuate actuator 340. In system 600, as shown, controller 302 determines the device ID 254 and button ID 256 from PDU 272 matches the corresponding entries in table 506. Further, controller 302 determines that the variable ID 278 from PDU 272 falls within the associated acceptable range 260 of variable IDs in table 506 (V012 is within the range of V002-V022). Accordingly, in response to determining the received IDs in PDU 272 satisfy the corresponding values of table 506, controller 302 is configured to actuate actuator 340, as illustrated with arrow 602. Further, after confirming the IDs in PDU 272 conform with table 506, controller 302 can store the IDs included in PDU 272 in memory 304 as IDs belonging to a paired device and use the IDs for future signal processing. For example, using PDU 272, controller 302 can determine the actual current variable ID 278 associated with control device 200 and thus generate a new range of acceptable anticipated variable IDs for a next received signal, where the new range of acceptable variable IDs is a narrower range than range 260.

FIG. 7 illustrates system 700 in which operator 300B receives its first control signal 280 from control device after 200 receiving the last recorded control device data from server 402 and generating the contents of table 506. As shown, control device 200 generates and transmits control signal 280 which is received by communication circuit 308 of operator 300. Control signal 280 comprises a PDU 282 which includes device ID 254, button ID 256, and variable ID 288. As previously discussed, device ID and button ID are common to all signals sent from control device 200 in response to the corresponding button being pressed, and variable ID 278 is different for each control signal from the control device 200 based on an encryption algorithm known by the control device 200 and operator 300B. Controller 302 of operator 300B analyzes the contents of PDU 282 and is configured to compare the values of the IDs of PDU 282 against the associated values stored in table 506. In response to the IDs included in PDU 282 matching the associated IDs stored in table 506, controller 302 is configured to verify the control signal as being sent from a source meant for controlling operator 300B and actuate the associated barrier with actuator 340. In response to determining that one of the IDs of PDU does not correspond with its associated ID in table 506, controller 302 is configured to ignore the received signal and not actuate actuator 340. In system 700, as shown, controller 302 determines that the device ID 254 and button ID 256 from PDU 272 match the corresponding entries in table 506. However, controller 302 determines that the variable ID 288 from PDU 282 falls outside the associated acceptable range 260 of variable IDs in table 506 (V032 is outside of the range of V002-V022). Accordingly, in response to determining the one of the received IDs in PDU 282 does not satisfy the corresponding values of table 506, controller 302 is configured to ignore signal 280 and not actuate actuator 340, as illustrated with arrow 702. Further, in some examples, in response to determining the one of the received IDs in PDU 282 does not satisfy the corresponding values of table 506, controller 302 is configured to provide feedback indicating the error. For example, when variable ID 288 is outside of range 260, controller 302 can display an error message via UI 331 that signal properties of control device 200 did not meet anticipated requirements and provide directions on pairing control device 200 with operator 300 via another pairing method.

This above disclosure has described both the device ID 254 and button ID 256 from the PDU being compared against the corresponding values in table 506. However, those with skill in the art will understand other examples fall within the scope of this disclosure. In some examples, one of either the device ID and button ID, along with the variable ID, is compared against values in table 506. That is, in various examples, just one of the device ID or button ID is analyzed from the PDU by controller 302. Additionally, FIG. 7 shows an example of ignoring a control signal 280 based on the variable ID 288 not falling within the range 260 of table 506. In addition, those with skill in the art will understand controller 302 is configured to ignore a received signal if any the other IDs of the PDU, such as the device ID or button ID, do not match the IDs associated with table 506. Additionally, while the depicted table 506 shows device information related to one control device, in various examples, table 506 is populated with device information for multiple control devices associated with the user’s account. That is, when the user provides their user credential 502 in FIG. 5, controller 302 receives information related to numerous control devices from server 402 so that operator 300B can be controlled by any of the user devices associated with the user’s account.

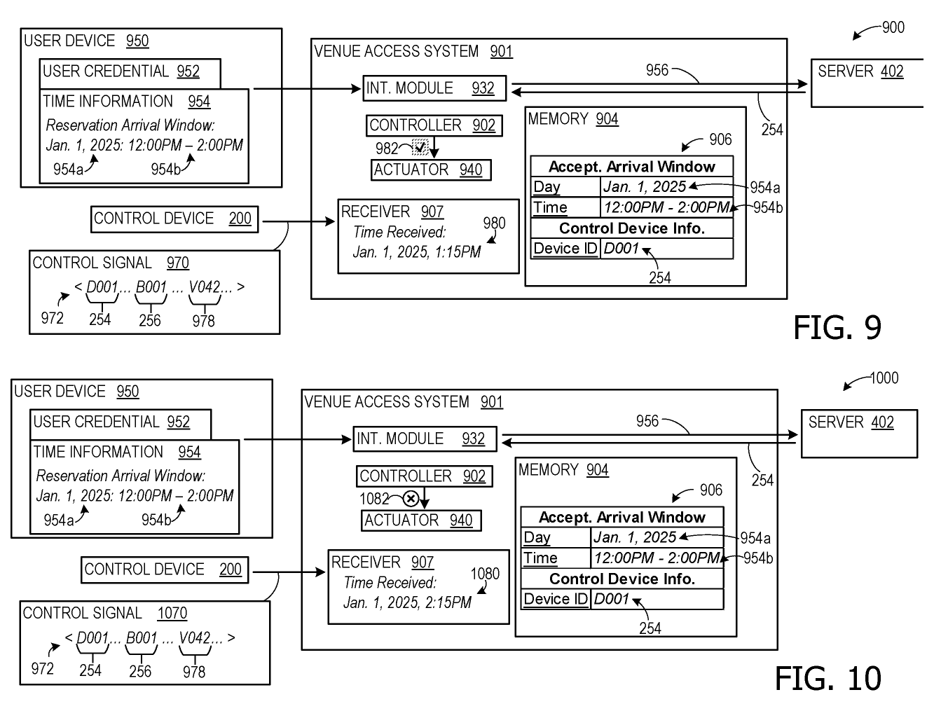

FIG. 8 is a flowchart illustrating a method 800 of operating a movable barrier system. Method 800 can begin at block 802 by transmitting a control signal 250 from control device 200 to operator 300A. Control device 200 and operator 300A can be operationally paired devices where controlling signals are configured to be sent by control device 200 and received and acted upon by operator 300A. Accordingly, in response to receiving control signal from block 802, controller 302 of operator 300A is configured to actuate barrier 112. Method 800 continues to block 806 where operator 300A stores signal properties of control signal 250, such as IDs 244, 256, 258 to remote server 402. As previously discussed, in some examples, operator 300A stores this information for every received signal from control device 200. In other examples, operator 300A stores this information periodically, such as by storing the information once every ten times a signal is received, for example. Method 800 can continue to block 808 where server 402 updates table 404 to include the IDs 244, 256, 258 from the last received control signal 250. As those with skill in the art will understand, blocks 802-808 can be repeated numerous times over the life of operator 300A.

For any of a number of reasons, a user of control device 200 may wish to use their control device 200 with a new operator 300B. The method can continue to block 810 by the user entering a user credential 502 associated with their movable barrier operator system user account at UI 331 of operator 300B. The method can continue by operator 300B sending a request 504, including user credential 502, to server 402 where server 402 verifies the request 504 in block 812. The serve confirms that the user credential 502 corresponds with the user’s account and in block 814 transmits the last received control signal information stored in table 404 to operator 300B. With this received information, in block 816, operator 300B determines and stores information of a next anticipated received control signal from control device 200. Specifically, in some examples, controller 302 of operator 300B determines the device ID 254, button ID 256, and variable ID range 260 for populating table 506, as has been previously discussed.

Method 800 can continue to block 818 where control device 200 transmits a control signal 270 that is received by operator 300B. The method can continue to block 820 where controller 302 of operator 300B identifies the data included in control signal 270 and compares the various pieces of data against corresponding values stored in the next anticipated control signal properties table 506 previously determined by the controller 302. Specifically, in some examples, controller 302 determines if device ID 254 and/or button ID 256 match corresponding values in table 506. Further, in some examples, controller 302 determines if variable ID 278 falls within the determined range 260 of acceptable variable IDs. In response to determining that the properties of the control signal 270 satisfies the entries in table 506, the method 800 can continue to block 822 where operator 300B actuates the associated barrier 112. In response to determining that the properties of the control signal do not satisfy the entries of table 506, operator 300B ignores the received signal and does not actuate the barrier, as previously discussed.

Although method 800 is illustrated as including blocks 802-822, those with skill in the art will understand that methods herein can include more or less than blocks 802-822 without departing from the scope of this disclosure. Additionally, although blocks 802-822 are depicted in a certain order, methods herein can include blocks 802-822 occurring in any of a number of different orders without departing from the scope of this disclosure.

As described, method 800 allows for a user to use an existing control device 200 for controlling an operator 300B unpaired with the control device 200. This with skill in the art will recognize the various use-cases in which method 800 can be implemented. For example, the user may replace an old operator (300A) with a new operator (300B) and seamlessly start using the new operator seamlessly without needing to perform a traditional pairing process between the existing control device and new operator. This is just one of many similar examples in which method 800 can be utilized.

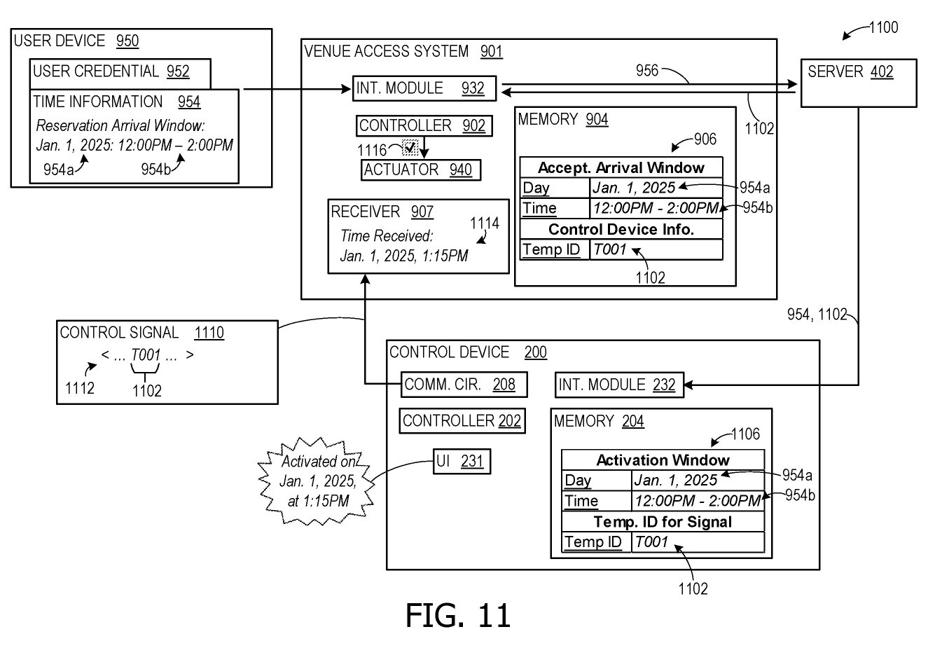

FIGS. 9 and 10 illustrate other systems 900, 1000 in which data stored in server 402 is utilized in for controlling a movable barrier operator with an unpaired control device 200. Specifically, systems 900, 1000 comprise a venue access system 901 for providing access to a designated venue. In some examples, the designated venue is a parking garage or lot, and the user can use the venue access system 901 to reserve a parking spot of the venue, and then use their personal control device 200 to control a movable barrier of the venue access system 901. Venue access system 901 can be used to control access of patrons or visitors for any of a number of venues. For example, public parking lots or garages can utilize venue access system 901 to allow visitors to reserve a parking spot at the parking facility. Similarly, venues with their own private parking areas, such as, for example, airports, theatres, arenas, hotels, apartment complexes, stadiums, and the like can utilize venue access system 901 to allow visitors to reserve a parking spot at the venue. As will become clear, venue access system 901 can also be used in other cases besides allowing access to parking facilities. For example, venue access system 901 can be used to allow a user access to barrier-access-controlled venue itself, such as an arena, stadium, etc., where occupant entry to venue can be controlled by a gate or other barrier.

As shown, in some examples, venue access system 901 is substantially similar to operator 300 previously discussed. Venue access system 901 includes a controller 902 (substantially similar to controller 302) operatively coupled with a memory 904 (substantially similar to memory 304). Additionally, controller 902 is operatively coupled with an internet module 932 (substantially similar to internet module 332) for communicating via an internet network, and with a signal receiver 907 (substantially similar to receiver 307 of communication circuit 308) for receiving control signals from a control device. Additionally, controller 902 is operatively coupled with actuator 940 (substantially similar to actuator 340) configured to actuate a moveable barrier of the venue.

As mentioned above, venue access system 901 can be utilized by a user to access a venue associated with the venue access system 901. The user utilizes a user device 950 to make a reservation at the venue. User device 950 can be any electronic device providing access to a website or web-based application managed by the venue or a reservation/parking service utilized by the venue, such as, for example, a smartphone, tablet, laptop, desktop computer, etc. To make a reservation at the venue, the user can access the venue website or application via user device 950, and venue access system gathers the reservation data via its connection to the internet by internet module 932. The reservation information can include user credential 952 associated with the user’s movable barrier operator account for control device 200. User credential 952 is substantially the same as user credential 502 previously discussed. The reservation can further include time information 954 related to the user’s anticipated time of arrival at the venue. The time information 954 can include a reservation date 954a and a reservation time 954b at which the user expects to arrive at the venue.

Controller 902 is configured to receive the time information 954 and the user credential 952 and generate a request 956 for sending to server 402. Specifically, request 956 includes the user credential 952 and is sent to server 402 requesting information related to control device 200 associated with the user credential 952. Specifically, in some examples, request 956 requests the various device-specific IDs associated with control device 200 discussed herein, such as the device ID, button ID, and/or variable ID. In this illustrative system 900, request includes a request for control device’s 200 device ID 254. Server 402 is configured to receive request 956 and verify that the user credential 952 corresponds with a credential associated with a user account maintained by the operator of server 402. In response to verifying the user credential 952, server 402 transmits the requested information of the control device 200 associated with the user credential 952, which, in this illustrative system, is device ID 254.

Upon receiving the control device information from server 405, controller 902 saves the received control device information and the time information to memory 904. As shown, in some examples, controller 302 populates table 906 of memory 904 with device ID 254 received from server 402 and time information 954. Thus, controller 302 is configured to reference table 506 and grant entry into the venue in response to receiving a control signal satisfying the values stored in table 506. For example, as shown in system 900 control signal transmits a control signal 970 with a PDU 972 including device ID 254, button ID 256, and variable ID 978, which is received by receiver 907. Controller 302 is configured to determine the signal-received-time 980, which represents the time at which signal 970 is received at receiver 907. Further, controller 902 is configured to identify one or multiple of the various IDs included in PDU. In system 900, controller 902 determines that the signal-received-time 980 falls within the time information 954a, 954b in table 906, and further, that the device ID 254 of PDU 972 matches the device ID received from server 402 and recoded in table 906. Accordingly, because all the values of table 906 are satisfied by the properties of received signal 970, controller 902 is configured to actuate actuator 940, as illustrated with arrow 982. Thereby, actuator 940 opens an associated barrier and grants entry to the associated venue for the user of control device 200. In some examples, where the user is using venue access system 901 as part of an ongoing service, such as a monthly parking subscription to a parking garage, controller 902 will continue to store the information in table 906 for as long as the duration of the subscription service for referencing for future signals received from control device 200. In other examples, where venue access system 901 is utilized as part of a one-time subscription, controller 902 will discard the data stored in table 906 after control signal 970 is verified and actuator 940 is actuated 982.

FIG. 10 shows an illustrative system in which the signal from control device 200 is ignored, and the user of control device 200 is not granted entry to the venue. System 100 is substantially the same as system 900 previously discussed, however, in system 1000, control signal 1070 is received by receiver 907 at a signal-received-time 1080 of 2:15PM, which is outside the time information window 954b stored in table 906. Accordingly, although the received device ID 254 satisfies the corresponding entry in table 906, the time information 954 is not satisfied by the signal 1070, and thus controller 902 ignores control signal 1070, as illustrated with arrow 1082. In some examples, by ignoring 1082 the control signal 1070, controller 902 does not acuate actuator 940 and thereby denies the user of control device 200 access to the associated venue. In some examples, the controller 902 sends a message via sever 402 to user device 950 indicating the error (i.e., signal received outside of expected arrival window) and providing instructions for complying with the expected arrival information or rebooking a reservation with venue access system 901.

FIG. 11 shows another illustrative system 1100 in which data from server 402 is used in operating venue access system 901. As shown, system 1100 is substantially similar to systems 900, 1000 previously discussed. However, in system 1100, server 402 is configured to generate a temporary device ID 1102 in response to request 956 rather than provide an established ID, such as device ID 254 or button ID 256 which, as has been discussed, are preestablished IDs associated with the control device 200. As shown, in response to receiving request 956, which includes the user credential 952 and the time information 954, from venue access system 901, server 402 generates and transmits temporary ID 1102 to venue access system via the network connection with internet module 932, and controller 902 stores the temporary ID 1102 in table 906 (temporary ID 1102 is represented as “T001” in this illustrative example).

Additionally, in response to receiving request 956, server 402 transmits the temporary ID 1102 and the time information 954 to control device via a network connection via internet module 232, control device 200 receives the temporary ID 1102 and time information 954 and stores the received data in memory 204, such as in table 1106, as shown. Controller 202 is configured to reference the data stored in table 1106 in generating control signals for transmission. In response to UI 231, such as a button of the UI 231, being activated within the time range defined by the time information 954 stored in table 1106, controller 202 is configured to include the temporary ID 1102 from table 1106 in the PDU of the control signal sent responsive to the activation. As shown, in this illustrative example, UI 231 is activated on Jan.1, 2025 at 1:15PM. Responsive to this activation, controller 302 generates control signal 1110 with PDU 1112. As shown, controller 302 includes temporary ID 1102 in PDU 1112 since the UI 231 was activated at a time satisfying the date and time information 954a, 954b stored to table 1106. Additionally, because the control signal 1110 is received by receiver 907 at a signal-received-time 1114 satisfying the time date and time information 954a, 954b stored to table 906, controller 902 activates actuator 940 (illustrated with arrow 1116), as has been discussed in previous systems herein.

In some examples, system 1100 is implemented in Bluetooth communication environments. As those with skill in the art will understand, Bluetooth signal generation allows for temporary IDs to be generated and included in transmission between communicating devices. Accordingly, in some examples, communication circuits 308 and 208 are Bluetooth communication circuits and control signal 1110 is a Bluetooth transmission signal. Temporary ID 1102, generated by server 402, is a Bluetooth compatible ID and included in the PDU 1112 by controller 202. According to various other examples, system 1100 is implemented in one of various known short-range communication environments, such as UWB, for example, and the temporary ID is a temporary ID generated according to the protocols of the communication technology being utilized.

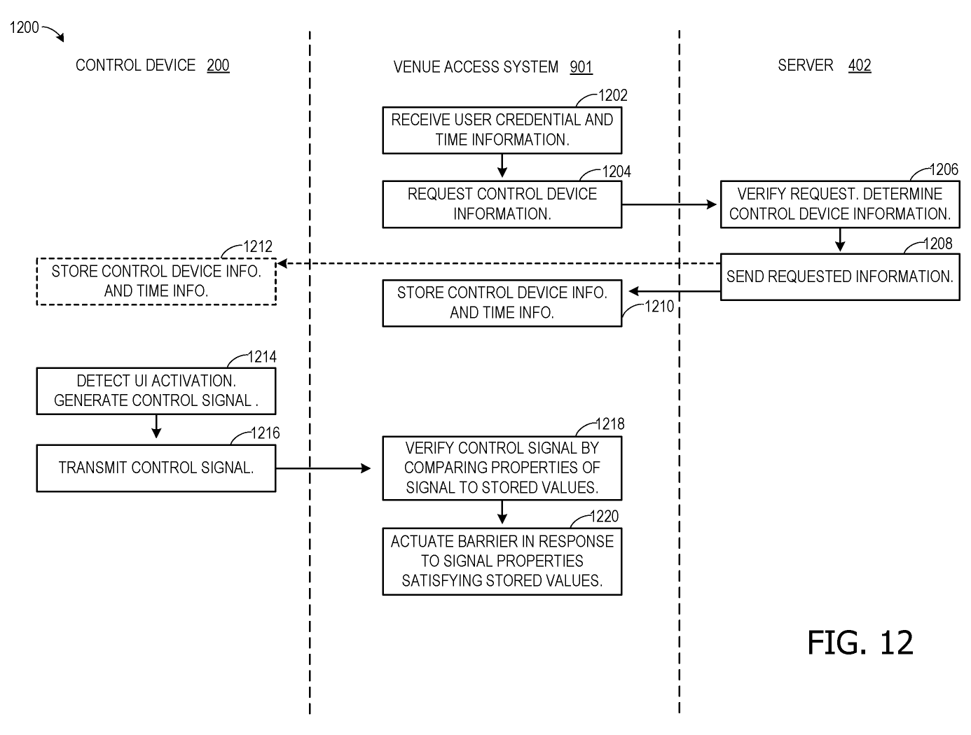

FIG. 12 is a flowchart illustrating a method 1200 of using a remote server 402 in controlling a venue access system with an unpaired control device 200. Method 1200 starts at block 1202 by venue access system 901 receiving a user credential 952 and time information 954. As discussed, the user can provide this information via a website or web application associated with the venue. Method 1200 can continue to block 1204 where the venue access system 901 transmits a request 956 to server 402 over a network, where the request 956 can include the user credential 952 and time information 954. The request 956 further includes a request for control device information of a control device associated with the user credential 952. Method 1200 can continue to block 1206 where server 402 receives request 956 and verifies the user credential 952 associated with the account of the user maintained by the operator of server 402. In response to determining that the user credential 952 matches a user account, the method 1200 can continue to block 1208 where the server 402 sends the control device information requested in request 956. In some examples, this includes transmitting device ID 254, button ID 256, and/or a variable ID or variable ID range associated with the control device 200, as discussed herein. In some examples, block 1208 includes generating and transmitting a temporary ID 1102 and the time information 954, as discussed in system 1100.

The method continues to block 1210 where the control device information sent by server 402 is received by venue access system 901 and stored in table 906. Optionally, in some examples, such as in system 1100, block 1208 includes sending the temporary ID 1102 and time information 954 to the control device 200 associated with the user credential 952. In these examples, the method continues at block 1212 by receiving the temporary ID 1102 and time information 954 and storing the data in table 1106. The method can continue to block 1214 by control device 200 controller 202 detecting an activation of UI 231 for operating a movable barrier and generating an associated control signal. In some examples, such as in system 1100, this includes controller 302 referencing table 1106 to determine if the time of the UI 231 activation qualifies for including the temporary ID 1102 in the control signal. The method 1200 can continue to block 1216 where the controller 302 transmits the control signal to venue access system 901. The method 1200 can continue to block 1218 where the venue access system controller 902 verifies the control signal by comparing properties of the control signal to corresponding values stored in table 906. In response to the properties of the control signal satisfy the corresponding values of table 906, the method continues to block 1220 where the controller 902 actuates actuator 940 to grant the user of control device 200 entry through the associated venue movable barrier. In response to determining that the properties of the control signal do not satisfy the corresponding values of table 906, controller 902 ignores the received signal and does not actuate the barrier, as previously discussed.

Although method 1200 is illustrated as including blocks 1202-1220, those with skill in the art will understand that methods herein can include more or less than blocks 1202-1220 without departing from the scope of this disclosure. Additionally, although blocks 1202-1220 are depicted in a certain order, methods herein can include blocks 1202-1220 occurring in any of a number of different orders without departing from the scope of this disclosure.

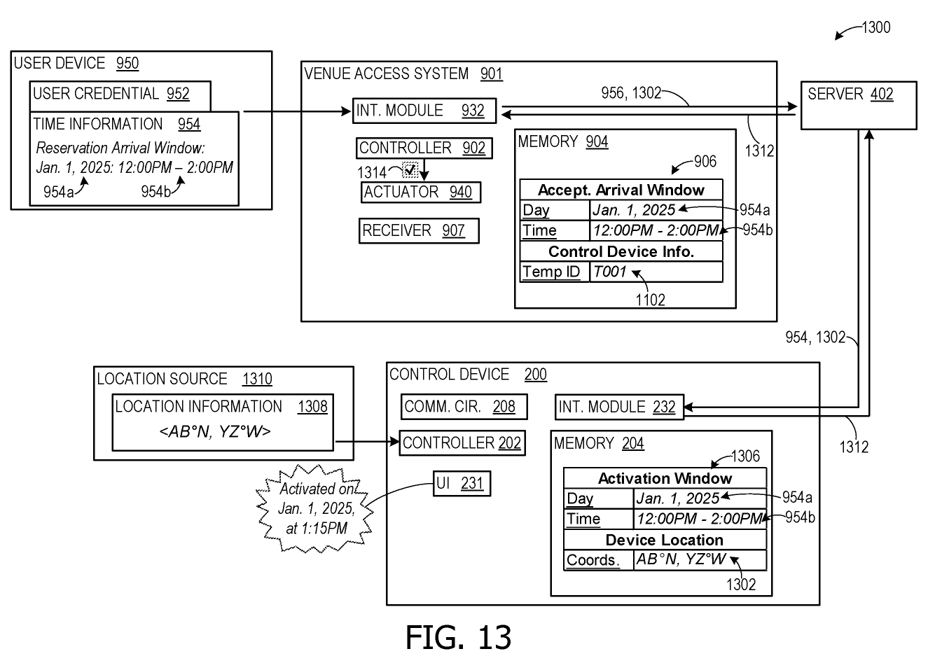

FIG. 13 shows another illustrative system 1300 in which data from server 402 is used in operating venue access system 901. As shown, system 1300 is substantially similar to systems 900-1100 previously discussed. However, in system 1300, control device 200 communicates with venue access system 901 through server 402 rather than sending control signals directly to venue access system via communication circuit 208. As shown, in system 1300, along with sending request 956 to server 402, controller 902 additionally sends venue location information 1302. Venue location information 1302 represents the location of the venue associated with venue access system 901, and can be stored to memory 904. Venue location information 1302 can be represented in any commonly used format, such as latitude and longitude coordinates or a street address, for example. After verifying the user credential 952 of request 956, server 402 transmits the time information 954 and location information 1302 to control device 200 associated with the user credential 952 via its network connection with control device 200. In some examples, server 402 adds a radius to location information 1302 so as to allow access to the venue by control device 200 within a certain radius of the venue. In some examples, controller 202 of control device 200 adds this radius to the location information 1302.

After receiving the time information 954 and location information 1302, controller 202 stores the information for future reference in memory 204, such as in table 1306, for example. Controller 202 references table 1306 when UI 231 in determining how to request access to venue access system 901. Controller 202 is configured to receive location information 1308 associated with the control device from a location source 1310. In some examples, location source is integral with control device 200 and can comprise any known module that utilizes location identification systems, such as global positioning systems (GPS) or cellular data location systems, for example. In some examples, location source 1310 is operatively coupled with control device 200, such as through wireless or wired communication. For example, control device 200 can receive location information 1308 from a vehicle’s or a phone’s location source 1310. In some embodiments, location source 1310 is a wireless location beacon associated with the venue access system 901 and is configured to wirelessly communicate with control device 200 within a certain range of the venue access system. Those with skill in the art will understand that location source 1310 and location information 1308 can comprise various known technologies used for determining the actual location associated with control device 200.

Upon activation of UI 231, controller 202 is configured to determine the time of activation of the UI 231, and also determine the location of the control device during the activation based on location information 1308. Controller 202 is configured to verify the UI 231 activation time and location information against the corresponding values stored in table 1306. In response to the activation time of UI 231 satisfying the time information 954a, 954b, and the location information 1308 from location source 1310 satisfying the venue location information 1302, controller 202 is configured to send a venue access request 1312 to server 402 to server via its network connection with server 402. Server 402 receives the venue access request 1312 to venue access system 901 as a request coming from a control device satisfying the location information 1302 and time information 954 previously provided to the server 402 by venue access system 901. In response to receiving the venue access request 1312, controller 902 is configured to actuate actuator 940, as shown with arrow 1314, and thereby grant access to the venue.

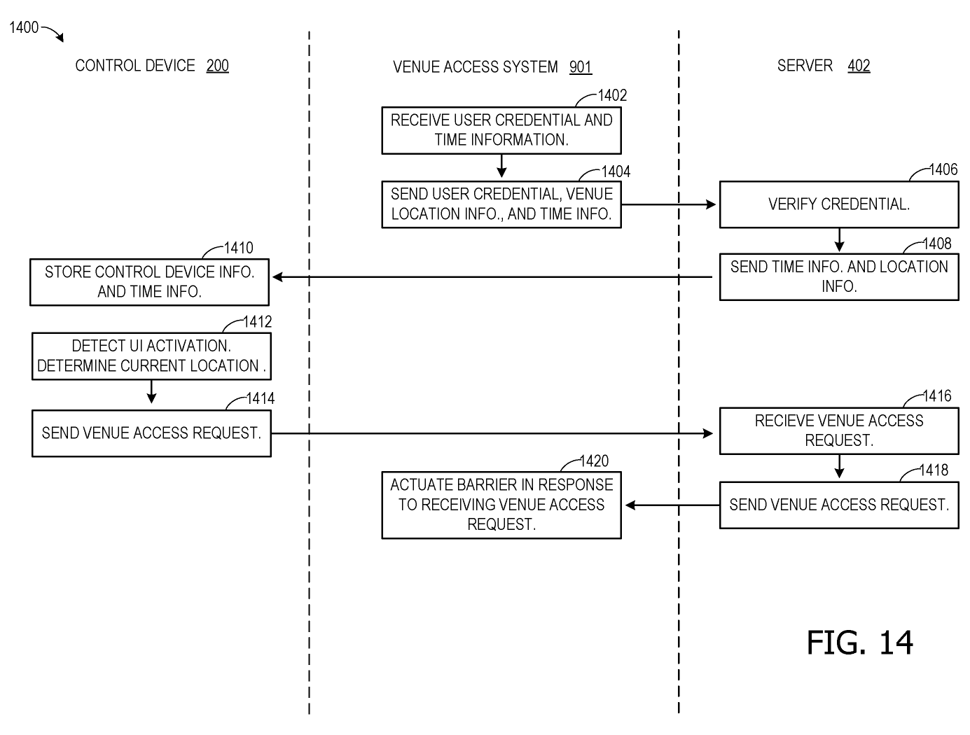

FIG. 14 is a flowchart illustrating a method 1400 for granting access to a venue. Method 1400 starts at block 1402 by venue access system 901 receiving a user credential 952 and time information 954. As discussed, the user can provide this information via a website or web application associated with the venue. Method 1400 can continue to block 1404 where the venue access system 901 sends a request 956 to server 402 over a network, where the request 956 can include the user credential 952 and time information 954. Block 1404 further includes sending the location information 1302. The request 956 is for requesting a future entry of a user of the control device associated with the user credential 952 at time satisfying the time information 954 and when the control device is located at the venue corresponding to the location information 1302. Method 1400 can continue to block 1406 where server 402 receives request 956 and verifies the user credential 952 associated with the account of the user maintained by the operator of server 402. In response to determining that the user credential 952 matches a user account, method 1400 can continue to block 1408 wherein the server sends the time information 954 and location information to the control device 200 associated with the user credential 952.

The method continues at block 1410 by the control device 200 receiving the time information 954 and location information 1302 and storing the data in table 1306. The method can continue to block 1412 by control device controller 202 detecting an activation of UI 231 for operating a movable barrier and generating an associated request. In some examples, such as in system 1100, this includes controller 202 referencing table 1306 to determine if the time of the UI 231 activation satisfies the corresponding time data in table 906. Additionally, controller 202 determines the location of device 200 during the UI 231 activation using location information 1308. The method 1200 can continue to block 1216 where, in response to the location information 1308 and time activation time of UI 231 satisfying the corresponding values in table 1306, the controller 302 transmits a venue access request 1312 to server 402 in block 1414. The method 1400 continues to block 1416 where the server 402 receives the venue access request 1312, and then block 1418, where server 402 sends the request 1312 to venue access system 901. The method continues to block 1420 where the controller 902 actuates actuator 940 to grant the user of control device 200 entry through the associated venue movable barrier after receiving the request 1312.

Although method 1400 is illustrated as including blocks 1402-1420, those with skill in the art will understand that methods herein can include more or less than blocks 1402-1420 without departing from the scope of this disclosure. Additionally, although blocks 1402-1420 are depicted in a certain order, methods herein can include blocks 1402-1420 occurring in any of a number of different orders without departing from the scope of this disclosure.

Those with skill in the art will understand that, although depicted as part of system 1300, according to various examples, the location information 1308 can be utilized in others of the various systems disclosed herein in a similar manner. For example, in system 1100, controller 202 can be configured to store location information 1302 in memory 204 and include the temporary ID 1102 in the control signal 1110 in response to determining that the control device 200 is at the venue based on the determined location information 1308. In system 1100, controller 202 can use the described location information 1308 and 1302 in addition to, or as an alternative to, time information 954. Additionally, according to various examples, operations of system 1100 and system 1300 can be combined. For example, control device 200 and/or server 402 can determine an appropriate way for requesting entry to venue access system 901, whether that be by a control signal sent directly from control device 200 to venue access system (as in system 1100), or by a network request through server 402 (as in system 1300). As an illustrative example, control device 200 and/or server 402 can determine that venue access system 901 is not compatible for receiving signals from control circuit 208 of control device 200, and thus that a request for entry to venue access system 901 should be sent through the network connection with server 402 (as discussed in system 1300).

Those with skill in the art will recognize the various uses-cases in which the described system and methods herein can be implemented. Traditionally, a user can make a reservation at a designated venue via an associated parking service website, and receive some sort of credential that must be verified at a kiosk or by a worker controlling the movable barrier granting access to the venue. For example, a user can be given a code, ticket, machine-readable code, or other credential that must be presented by the user at the kiosk at the time of arrival. This traditional process can lead to lengthy delays at the entrance of the venue, as each entrant must find and present their credential, which must then be processed by the kiosk or barrier attendant. In instances where venue entrants are all coming to the venue for an event starting at a certain time, such as a sporting event or concert, this can create a bottleneck at the entry of the venue and lead to long wait times for the entrants. The systems and methods described herein allow for entry to a venue using control devices already in the possession of the entrants for actuating the movable barrier controlling the entrance. Accordingly, the entrant can simply activate their control device to enter the venue rather than locating their venue-provided credential and submitting it for processing at the entry kiosk. Thereby, the methods and systems herein reduce the amount of entrant wait time and improve the efficiency of venue access systems.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. An operator for a movable barrier, comprising:
an actuator configured to actuate the movable barrier; and
a processor configured to:
receive a user credential,
retrieve control device information of a control device associated with the user credential from a remote operator server, the control device information including a device ID associated with the control device and a variable ID established via an encryption code and associated with a last recorded use of the control device,
determine, using the encryption code, a range of variable IDs associated with a next anticipated use of the control device,
receive, via a signal receiver of the operator, a control signal from the control device,
identify the device ID and the variable ID from the received control signal, and
control the actuator in response to verifying the control signal by determining that (i) the device ID from the control signal matches the device ID from the remote operator server and (ii) the variable ID from the control signal is within the determined range of variable IDs.

2. The operator of claim 1, wherein the device ID is a general device ID associated with control device and included in signals transmitted by the control device in response to any of a plurality of actuation buttons of the control device being activated.

3. The operator of claim 1, wherein the device ID is a button ID associated with one of a plurality of actuation buttons of the control device and included in signals transmitted by the control device in response to the one of a plurality of actuation buttons being activated.

4. The operator of claim 1, wherein the last recorded use of the control device is from a use of the control device with an original operator different from the operator.

5. The operator of claim 4, wherein the variable ID belonging to the control signal transmitted during the last recorded use of the control device and received by the original operator is transmitted by the original operator to the remote operator server.

6. The operator of claim 1, wherein the encryption code is a rolling code.

7. The operator of claim 1, wherein the processor is further configured to:
store the determined range of variable IDs in a memory of the operator for refence in verifying the control signal;
in response to determining that the variable ID from the control signal is outside of the range of the variable IDs, provide feedback indicating the variable ID does not meet stored requirements; and
in response to the variable ID from the control signal being within the range of the variable IDs, create a new range of variable IDs using the variable ID, wherein the new range of variable IDs narrower than the range of variable IDs.

8. A system for providing access to a designated venue, comprising:
a control device associated with an operator account of a user and configured to transmit control signals for actuating movable barriers; and
a server associated with the control device and remote from the designated venue, wherein the server is configured to, in response to receiving a user credential and determining that the credential corresponds with the operator account of the user:
receive parking information associated with the user parking at the designated venue,
determine a control device ID associated with the control device, and
transmit the parking information and the control device ID to a venue processor associated with the designated venue for the venue processor to use in operating a barrier system of the designated venue.

9. The system of claim 8, wherein the control device ID comprises a temporary wireless protocol ID created by the server.

10. The system of claim 9, wherein:
the server is communicatively coupled with the control device; and
the server is further configured to transmit the temporary wireless protocol ID to the control device.

11. The system of claim 8, wherein the control device ID is a general device ID associated with the control device and included in signals transmitted by the control device in response to any of a plurality of actuation buttons of the control device being activated.

12. The system of claim 8, wherein the control device ID is a button ID associated with one of a plurality of actuation buttons of the control device and included in signals transmitted by the control device in response to the one of a plurality of actuation buttons being activated.

13. The system of claim 8, wherein parking information comprises timeframe information associated with the user’s expected arrival at the designated venue.

14. A system for providing access to a designated venue, comprising:
a venue processor configured to:
receive a user credential via a user interface operatively coupled with the venue processor, the user credential associated with a movable barrier operator account of the user,
retrieve, from a movable barrier operator server using the user credential, a control device ID associated with a control device registered to the movable barrier operator account,
receive a control signal from the control device via a signal receiver coupled to the venue processor,
identify the control device ID from the control signal, and
actuate a venue movable barrier of the designated venue to grant a user entry to the designated venue in response to determining that the control device ID from the control signal matches the control device ID retrieved from the movable barrier operator server.

15. The system of claim 14, wherein the user interface is further configured to receive timeframe information associated with the user’s expected arrival at the designated venue.

16. The system of claim 15, wherein the venue processor is further configured to:
in response to determining that the control device ID from the control signal matches the control device ID retrieved from the movable barrier operator sever and that the control signal is received by the signal receiver within a at a time within the timeframe information, actuate the venue movable barrier to grant the user entry to the venue, and
in response to determining that the control signal is received by the signal receiver at a time outside of the timeframe information, ignore the control signal to deny the user entry to the designated venue.

17. The system of claim 14, wherein the control device ID comprises a temporary wireless protocol ID created by the movable barrier operator server.

18. The system of claim 17, wherein the temporary wireless protocol ID created by the movable barrier operator sever is transmitted to the control device for the control device to incorporate in the control signal transmitted to the signal receiver coupled with the venue processor.

19. The system of claim 14, wherein the control device ID is a general device ID associated with the control device and included in signals transmitted by the control device in response to any of a plurality of actuation buttons of the control device being activated.

20. The system of claim 14, wherein the control device ID is a button ID associated with one of a plurality of actuation buttons of the control device and included in signals transmitted by the control device in response to the one of a plurality of actuation buttons being activated.
